(19) United States
(12) Patent Application Publication
(10) Pub. No.: US 2026/0242165 A1
(43) Pub. Date: Aug. 20, 2026

(54) MEDIUM STORAGE AND MEDIUM PROCESSING DEVICE

(71) Applicant: Oki Electric Industry Co., Ltd., Tokyo (JP)

(72) Inventor: Ryuusei SHIMIZU, Tokyo (JP)

(73) Assignee: Oki Electric Industry Co., Ltd., Tokyo (JP)

(21) Appl. No.: 18/995,066

(22) PCT Filed: Aug. 15, 2023
(86) PCT No.: PCT/JP2023/029546

§ 371 Date: Jan. 15, 2025

(30) Foreign Application Priority Data
Oct. 21, 2022 (JP) 2022-169056

(51) Int. Cl. B65H 3/06; B65H 3/32; G07D 11/16

(52) U.S. Cl. CPC B65H 3/06; B65H 3/32; G07D 11/16

(57) ABSTRACT

A reject/collection box of a banknote processing device includes a first restriction member provided at a front end of a partition plate member of a partition plate and also a second restriction member provided at a front side of the first restriction member. In the reject/collection box, even when a banknote placed at a placement location has ridden up on the first restriction member, a front end of the banknote is abutted against the second restriction member, and the banknote is sufficiently separated from a vicinity of base portions of flippers of a flipper roller.

### DESCRIPTION

### Technical Field

The present application claims priority from the disclosure of Japanese Patent Application No. 2022-169056 filed on Oct. 21, 2022, which is incorporated by reference herein in its entirety.

The present disclosure relates to a medium storage and medium processing device applicable, for example, to a register change system employed at a checkout location of a retailer, such as a supermarket, a convenience store, or the like.

### Background Art

In a register change system, there is a growing trend to combine a change machine that performs pay-in/pay-out processing of banknotes and coins with a point of sales (POS) register connected to a POS system or the like. Such a change machine incorporates, for example, as well as a control unit to perform overall integrated control, also incorporates a banknote processing device for processing banknotes, a coin processing device for processing coins, and the like.

Such a banknote processing device is provided with, for example, a pay-in/pay-out section for providing and receiving banknotes, a conveyance section for conveying banknotes, a classification section for classifying banknotes, a storage box for storing banknotes that are reusable, a reject box for storing reject banknotes not able to be reused, a collection box for storing banknotes that should be collected in, and the like. As a banknote processing device, there is a proposal for a configuration including a reject/collection box that integrates a collection box and a reject box together, with the reject/collection box configured so as to be easily attached to or detached from a main device (see, for example, paragraph [0033] and FIG. 2 etc. of Japanese Patent Application Laid-Open (JP-A) No. 2020-17013).

Such a reject/collection box includes a moveable partition plate arranged inside a casing, with the upper side of the partition plate serving as the reject box, and the lower side of the partition plate serving as the collection box. The reject/collection box is provided with only one discharge mechanism for discharging banknotes, and the storage destination of banknotes discharged from the discharge mechanism can be easily switched between the reject box or the collection box by displacing the partition plate. Such a banknote processing device obtains a more compact and simpler device configuration, as well as enabling banknotes that should be collected and reject banknotes to be taken out easily and handled en bloc.

### SUMMARY OF INVENTION

### Technical Problem

However, in the reject/collection box described above, the reject banknotes are stored at the upper side of the partition plate, and in cases in which they stick out from the appropriate storage location, these reject banknotes might interfere with other components at the periphery thereof, with a possibility that the partition plate is no longer able to be displaced to the appropriate position. A concern in such cases is that the reject banknotes and the banknotes that should be collected might no longer be able to be appropriately stored, in the reject/collection box, in the reject box at the upper side of the partition plate or the collection box at the lower side thereof.

In consideration of the above circumstances, the present disclosure provides a medium storage and a medium processing device obtaining storing a medium appropriately inside respective spaces partitioned by a displaceable partition plate.

### Solution to Problem

In order to address the above issue, a medium storage according to an aspect of the present disclosure includes: a casing including an internal storage space for storing a paper leaf-shaped medium in a state stacked along a stacking direction; a discharge section for discharging the medium into the storage space; a partition plate that partitions an interior of the storage space into a first storage space on a contra stacking direction side thereof, which is opposite to the stacking direction side thereof, and a second storage space on the stacking direction side thereof, and that is provided with a placement location for placing the medium on a placement face that is a surface on the stacking direction side; a partition plate displacement section that displaces the partition plate between a first position that causes the medium discharged from the discharge section to progress into the first storage space, and a second position that is positioned further toward the contra stacking direction side than the first position and that causes the medium discharged from the discharge section to progress into the second storage space; a rotating member that includes one or more resiliently deformable resilient member extending in a direction away from a center axis disposed along a width direction orthogonal to the stacking direction, and that rotates about the center axis so as to assist stacking of the medium discharged into the storage space; a first restriction member that is provided at the contra stacking direction side of the partition plate on the discharge section side of the placement location, and that restricts a movement range toward the discharge section side of the medium placed on the placement location; and a second restriction member that is provided at the contra stacking direction side of the partition plate further toward the discharge section side than the first restriction member, and that restricts a movement range toward the discharge section side of the medium placed on the placement location.

Moreover, a medium processing device according to another aspect of the present disclosure includes a conveyance section that conveys a medium having a sheet-like shape; and a medium storage for storing the medium, wherein the medium storage includes: a casing including an internal storage space for storing a paper leaf-shaped medium in a state stacked along a stacking direction; a discharge section for discharging the medium into the storage space; a partition plate that partitions an interior of the storage space into a first storage space on a contra stacking direction side thereof, which is opposite to the stacking direction side thereof, and a second storage space on the stacking direction side thereof, and that is provided with a placement location for placing the medium on a placement face that is a surface on the stacking direction side; a partition plate displacement section that displaces the partition plate between a first position that causes the medium discharged from the discharge section to progress into the first storage space, and a second position that is positioned further toward the contra stacking direction side than the first position and that causes the medium discharged from the discharge section to progress into the second storage space; a rotating member that includes one or more resiliently deformable resilient member extending in a direction away from a center axis disposed along a width direction orthogonal to the stacking direction, and that rotates about the center axis so as to assist stacking of the medium discharged into the storage space; a first restriction member that is provided at the contra stacking direction side of the partition plate on the discharge section side of the placement location, and that restricts a movement range toward the discharge section side of the medium placed on the placement location; and a second restriction member that is provided at the contra stacking direction side of the partition plate further toward the discharge section side than the first restriction member, and that restricts a movement range toward the discharge section side of the medium placed on the placement location.

In these aspects of the present disclosure, the medium discharged from the discharge section is placed on the placement location in a state in which the partition plate has been positioned in the second position, and even in a case in which the medium has displaced toward the discharge section side and ridden up on the first restriction member, a movement range thereof is restricted by the second restriction member. This means that when displacing the partition plate from the second position to the first position, these aspects of the present disclosure avoid excessive force from the resilient member of the rotation member acting on the medium placed on the placement location, enabling the partition plate to be smoothly displaced.

The present disclosure enables implementation of a medium storage and a medium processing device able to appropriately store a medium in respective spaces partitioned by a displaceable partition plate.

### BRIEF DESCRIPTION OF DRAWINGS

FIG. 1 is a schematic perspective view illustrating a configuration of a banknote processing device.

FIG. 2 is a schematic side view illustrating a configuration of a banknote processing device.

FIG. 3A is a schematic side view illustrating a configuration of a reject/collection box.

FIG. 3B is a schematic side view illustrating a configuration of a reject/collection box.

FIG. 4 is a schematic plan view illustrating a configuration of a reject/collection box.

FIG. 5 is a schematic perspective view illustrating a configuration of a partition plate.

FIG. 6 is a schematic side view illustrating an enlargement of part of a reject/collection box.

FIG. 7 is a schematic diagram illustrating a configuration of a hypothetical reject/collection box in which second restriction members have been omitted from the partition plate.

FIG. 8 is a schematic diagram illustrating a configuration of a hypothetical reject/collection box with a changed position of a second restriction member on a partition plate.

FIG. 9 is a schematic diagram illustrating a configuration of a hypothetical reject/collection box with a changed position of a second restriction member on a partition plate.

FIG. 10 is a schematic plan view illustrating a state in which banknotes have been stored on a partition plate in a reject/collection box.

FIG. 11 is a schematic plan view illustrating a state in which a skew has developed in banknotes stored on a partition plate in a reject/collection box.

FIG. 12 is a schematic side view illustrating a state in which banknotes stored on a partition plate in a reject/collection box interfere with a casing.

### DESCRIPTION OF EMBODIMENTS

Description follows regarding embodiments for implementing the discloser (hereafter referred to as exemplary embodiments), with reference to the drawings.

### 1. Banknote Processing Device Configuration

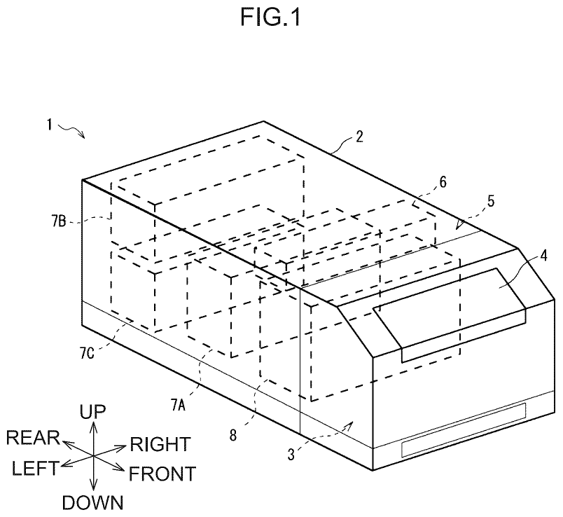

As illustrated in the external view of FIG. 1, a banknote processing device 1 serving as a medium processing device is incorporated in a non-illustrated POS register (not illustrated in the drawings) and, based on control of an integrated control unit provided to the POS register, various processing is performed related to banknotes, which are a paper leaf-shaped medium. This POS register is, for example, a checkout machine installed at a checkout location (so-called register) of a retailer, such as a supermarket, a convenience store, or the like, and is operated by a cashier when checking-out products that a customer wishes to purchase. In the following description a side face of the banknote processing device 1 on the side faced by a cashier (hereafter also referred to as a user), and the opposite face thereto, are respectively called a front face and a rear face, and left/right and up/down are defined from the perspective of the user.

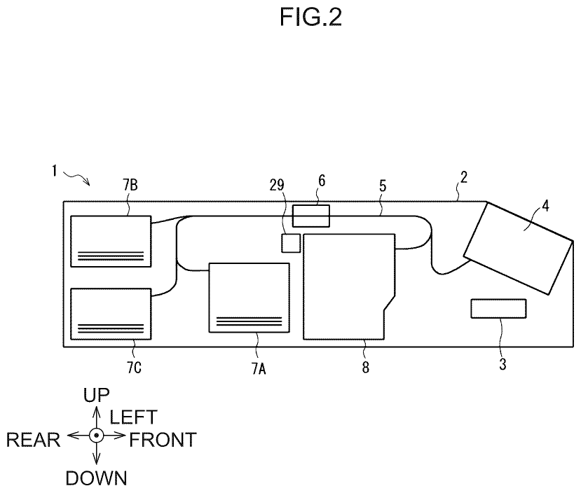

As illustrated in the schematic side view of FIG. 2, the banknote processing device 1 includes, disposed in the interior of a banknote processing device casing 2, a control unit 3, a pay-in section 4, a conveyance section 5, a recognition section 6, storage boxes 7 (7A, 7B, and 7C), as well as a reject/collection box 8 and the like. The control unit 3 is configured by a non-illustrated central processing unit (CPU) as a main part, and integrated control of the banknote processing device 1 and various processing such as pay-in processing and pay-out processing is performed by the CPU reading out and executing various programs, such as a change pay-out program and the like, from memory such as flash memory.

The pay-in section 4 is positioned at a front-side upper portion inside the banknote processing device 1. After banknotes are paid in by the user (cashier), the pay-in section 4 takes in the banknotes one note at a time while separating them, and feeds them out in sequence to the conveyance section 5. The conveyance section 5 is configured from plural non-illustrated rollers and belts, conveyance guides, and the like, and conveys the banknotes along conveyance paths. Branch points connected to plural conveyance paths are also provided in the conveyance section 5, with the progression path of banknotes switched under control from the control unit 3.

The recognition section 6 is incorporated on a conveyance path of the conveyance section 5, and employs optical elements and magnetic detection elements and the like on banknotes being conveyed to recognize the denomination and authenticity of the banknotes, condition (whether damaged or not), and conveyance state, and notifies the results of this classification to the control unit 3. In response thereto, the control unit 3 determines a conveyance destination of each of the banknotes based on the acquired classification results.

The storage boxes 7 each include a storage space for storing banknotes in a stacked state, a separation/stacking section for performing separation and stacking of the banknotes, and the like. Each of the storage boxes 7 (7A, 7B, and 7C) has been assigned a respective denomination of banknotes to be stored therein. After receiving banknotes from the conveyance section 5 that have been determined in the recognition section 6 and the control unit 3 to be reusable due to having a small amount of damage, the storage box 7 stacks and stores these banknotes in the internal storage space. On receipt of an instruction from the control unit 3 to feed out banknotes, the storage box 7 separates stacked banknotes and feeds them out one-by-one, so as to be delivered to the conveyance section 5 and conveyed thereby.

The reject/collection box 8 is configured so as to be easily attached to or detached from the banknote processing device casing 2. The reject/collection box 8 includes an internal storage space for stacking and storing banknotes, and is configured so as to be able to store reject banknotes and collection banknotes in a differentiated state (described in detail later). The reject banknotes are banknotes recognized in the recognition section 6 and the control unit 3 as banknotes having a large amount of damage, recognized as being forgeries, or the like, and are banknotes that have been determined as being unsuitable for reuse. The collection banknotes are, for example, banknotes conveyed in from the storage boxes 7 by the conveyance section 5 in cases in which part of sales money of a retailer is to be collected.

### 2. Reject/Collection Box Configuration

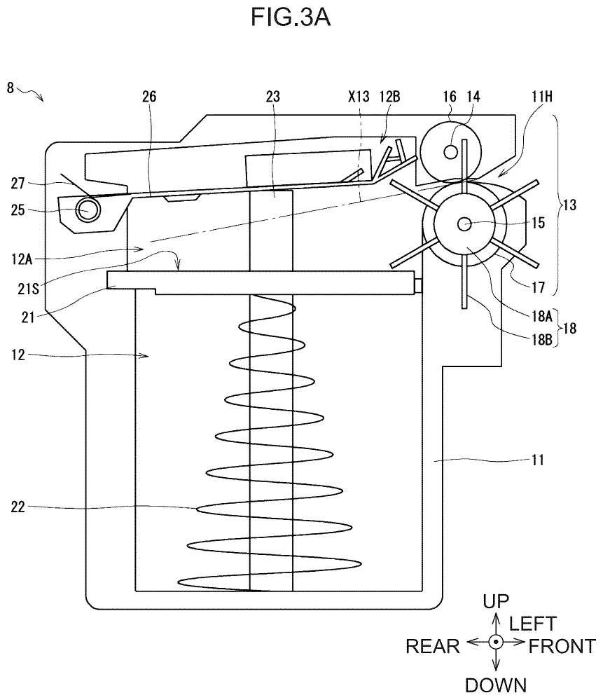

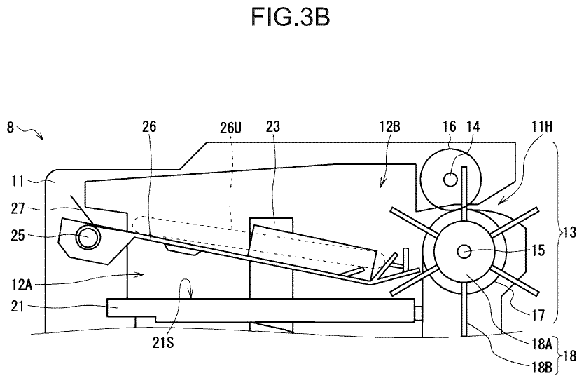

Next, detailed description follows regarding a configuration of the reject/collection box 8. The reject/collection box 8 is configured overall with a cuboidal shape, as illustrated in outline FIG. 1 and FIG. 2, and is configured long in a left-right direction and slightly shorter in the front-rear direction. As illustrated in the schematic side view of FIG. 3A, the reject/collection box 8 includes a storage space 12 formed in the interior of a casing 11 configured with a cuboidal shape, with various components attached to the casing 11.

A through hole 11H is provided at a location toward an upper end of the front face of the casing 11 so as to pierce through in the front-rear direction. The through hole 11H has an vertical direction length sufficiently larger than a thickness of a banknote, and has a left-right direction length slightly longer than a length of the long side of a banknote. The through hole 11H communicates the storage space 12 inside the casing 11 with an external space, and enables banknotes to be passed through in a state in which their long sides are along the left-right direction.

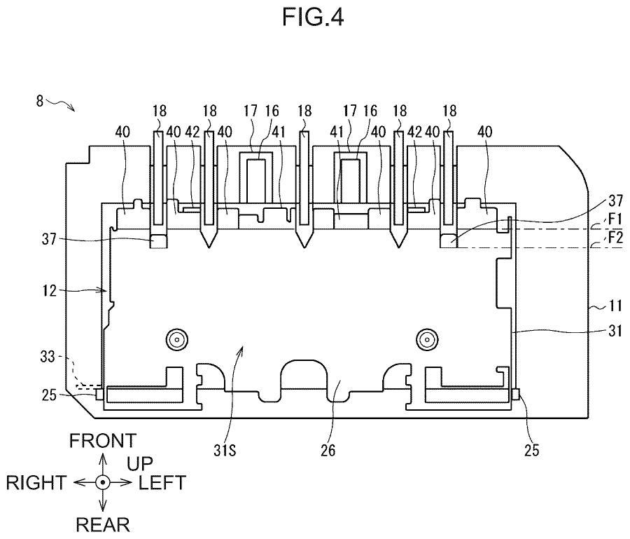

A discharge section 13 is provided at a periphery of the through hole 11H for discharging banknotes into the inside of the storage space 12. The discharge section 13 is configured including an upper rotation shaft 14, a lower rotation shaft 15, two upper rollers 16, two lower rollers 17, five flipper rollers 18, and the like. FIG. 4 is a plan view schematic representation of the casing 11 omitting an upper plate and the like above the storage space 12.

The upper rotation shaft 14 serving as a second rotation shaft is a thin elongated circular pillar shaped member disposed along the left-right direction, and is rotatably supported above the through hole 11H by part of the casing 11. The upper rotation shaft 14 is rotated clockwise in FIG. 3A by drive force supplied from a specific stacking motor (not illustrated in the drawings) provided to the banknote processing device casing 2. The lower rotation shaft 15 is a thin elongated circular pillar shaped member disposed along the left-right direction, similarly to the upper rotation shaft 14, and is rotatably supported below the through hole 11H by part of the casing 11. The lower rotation shaft 15 rotates counterclockwise in FIG. 3A by drive force supplied from a specific stacking motor (not illustrated in the drawings) provided to the banknote processing device casing 2.

The upper rollers 16 (FIG. 3A) each serve as a second roller and are formed in a circular pillar shape with a center axis extending along the left-right direction,. The upper rotation shaft 14 is inserted through a central portion of each of the upper rollers 16, and the upper rollers 16 rotate as one with the upper rotation shaft 14. The upper rollers 16 are each arranged at a position slightly displaced away from a left-right direction center of the casing 11 toward the outer side thereof, and a lower end vicinity thereof is exposed inside of the through hole 11H. The lower rollers 17 each serve as a first roller and, similarly to the upper rollers 16, are formed in a circular pillar shape with a center axis extending along the left-right direction. The lower rotation shaft 15 is inserted through a central portion of each of the lower rollers 17, and the lower rollers 17 rotate as one with the lower rotation shaft 15. The lower rollers 17 are each arranged at a position slightly displaced away from a left-right direction center of the casing 11 toward the outer side thereof, at a position facing the respective upper roller 16, and an upper end vicinity thereof is exposed inside of the through hole 11H and also abuts the upper roller 16. Namely, the upper rollers 16 and the lower rollers 17 are arranged so as to be adjacent to each other substantially along a stacking direction.

In a state in which the upper rollers 16 and the lower rollers 17 have been respectively rotated and a banknote has been conveyed in by the conveyance section 5 (FIG. 1 and FIG. 2), the discharge section 13 configured in this manner nips the banknote, causing a progression force in the rearward direction to act thereon, thereby passing the banknote through the through hole 11H and discharging the banknote into the storage space 12. When doing so, the banknote progresses diagonally rearward and downward into the storage space 12, with an imaginary discharge line X13 that is a common tangent to the upper rollers 16 and the lower rollers 17 serving as an ideal trajectory.

Each of the flipper rollers 18 serving as a rotation member is configured from a central roller section 18A and six flippers 18B. The central roller section 18A is formed in a circular pillar shape slightly smaller than the lower rollers 17, with the lower rotation shaft 15 inserted through a central portion thereof, and the central roller section 18A rotating as one with the lower rotation shaft 15. Each of the flippers 18B serves as a resilient member disposed along a radial direction from the center of the central roller section 18A and configured from a flexible material with a thin elongated pillar shape or bar shape. The flipper rollers 18 are arranged with one thereof between the two lower rollers 17, with two thereof respectively arranged at each of the left and right outsides of respective lower rollers 17, so as to be arranged spaced out from each other by a specific spacing. The flippers 18B of flipper rollers 18 extend further out from the lower rotation shaft 15 than the outer peripheral face of the lower rollers 17, jut out by a large amount from the casing 11 toward the space at the inside and outside of the storage space 12 when in their natural state, and resiliently deform by abutting other components, banknotes, and the like.

In cases in which a banknote has been discharged to inside the storage space 12 by the upper rollers 16 and the lower rollers 17, when part of this banknote is positioned within the rotation trajectory of the flippers 18B of the flipper rollers 18, then the flippers 18B hit this banknote downward, and the banknote is dragged slightly forward under action of friction between the flippers 18B and the banknote. Note that, focusing on the effective action on the banknotes stacked in the storage space 12, the flipper rollers 18 may also be called an impeller.

So as not to impeded such rotation, an indent, a cutout, or the like is appropriately formed in the casing 11 at respective locations corresponding to the upper rollers 16, the lower rollers 17, and the flipper rollers 18, by forming in shapes corresponding thereto.

A stage 21, a stage spring 22, a stage guide 23, and the like are provided inside the storage space 12 (FIG. 3A). The stage 21 has a plate shape thin in the vertical direction, with a stage placement face 21S that is the upper face thereof formed substantially flat. The stage spring 22 is provided between a lower face of the stage 21 and a bottom portion at on the inside face of the casing 11, with a resilient force from the stage spring 22 acting upwards on the stage 21.

The stage guide 23 is configured by rail components provided along the vertical direction at the left and right inside faces of the casing 11, and by guide components and the like that are able to slide with respect to the rail components and that are attached to left and right ends of the stage 21. The stage guide 23 enables the stage placement face 21S of the stage 21 to be moved smoothly along the vertical direction while being maintained substantially horizontal.

Due to adopting such a configuration in the reject/collection box 8, when a banknote is discharged from the discharge section 13, the banknote is hit against the stage 21 and also pulled toward the front side by the flippers 18B of the flipper rollers 18, and placed on the stage placement face 21S in an orientation in which faces of the paper are facing in the vertical direction. By repeating this action, the reject/collection box 8 sequentially superimposes the banknotes on the stage placement face 21S and performs stacking.

Namely, the flipper rollers 18 assist banknotes discharged to the storage space 12 being stacked on the stage placement face 21S. When this is being performed, the stage 21 is gradually lowered downward due to the stage spring 22 being compressed according to the weight of the stacked banknotes. For ease of explanation, hereafter the upward direction will also be called a stacking direction, and the downward direction will be called a contra stacking direction. Furthermore, left-right directions orthogonal to the upward direction, which is the stacking direction, will also be called a width direction.

In addition thereto, a partition plate rotation shaft 25, a partition plate 26, and a partition plate rotation spring 27 are provided in the reject/collection box 8 at portions at the upper side of the interior of the storage space 12. The partition plate rotation shaft 25 is a circular pillar shaped member having a central axis along the left-right direction, and is supported by the casing 11 at an upper rear side of the storage space 12.

The partition plate 26 is configured overall with a plate shape, thin in the vertical direction, and with plural cutout shapes, plural projection shapes, and the like provided at each portion as illustrated in FIG. 4 (described in detail later). Shaft holes 26H configured by round holes passing through in the left-right direction are provided to portions projecting so as to face downward at plural locations in a rear end vicinity of the partition plate 26 (FIG. 3A). The partition plate rotation shaft 25 is inserted through each of the shaft holes 26H.

This means that the partition plate 26 is able to rotate counterclockwise or clockwise in FIG. 3A about the partition plate rotation shaft 25. For example, when the partition plate 26 has been rotated as far as possible counterclockwise, as illustrated in FIG. 3A, a front end side thereof can be positioned further upward than the through hole 11H, and the lower face thereof can be positioned slightly further upward than the imaginary discharge line X13. Hereafter the position of the partition plate 26 thereat is called a collection position or a first position.

In cases in which the partition plate 26 is in the collection position as described, the reject/collection box 8 places banknotes discharged from the discharge section 13 into the storage space 12 onto the stage 21, enabling stacking thereof. The portion inside the storage space 12 that is below the partition plate 26 and above the stage 21 is called a collection storage space 12A or a first storage space. The collection storage space 12A is presumed to be stored with banknotes (hereafter referred to as collection banknotes) conveyed in by the conveyance section 5 from the storage boxes 7, for example when banknotes stored in the storage boxes 7 are being collected.

On the other hand, in cases in which the partition plate 26 has been rotated as far as possible clockwise, a front end side thereof is able to be positioned at the lower side of the through hole 11H, enabling the upper face of the front end side to be positioned slightly below the imaginary discharge line X13, as illustrated in FIG. 3B corresponding to part of FIG. 3A. Hereafter the position of the partition plate 26 when this is performed will be called a reject position or a second position.

In cases in which the partition plate 26 is in the reject position as described, the reject/collection box 8 enables banknotes discharged from the discharge section 13 into the storage space 12 to be placed on top of the partition plate 26, and stacked thereon. Hereafter a portion inside the storage space 12 and at the upper side of the partition plate 26 will be called a reject storage space 12B or a second storage space. This reject storage space 12B is presumed to be stored with reject banknotes conveyed in by the conveyance section 5 that were recognized as being unsuitable for reuse by the recognition section 6. A location on the partition plate 26 where reject banknotes should be placed is called a placement location 26U.

The partition plate rotation spring 27 is, for example, a torsion spring, with the partition plate rotation shaft 25 inserted through a portion thereof that is formed in a circular cylinder shape, with one end thereof positioned at the lower side of the partition plate 26 and the other end thereof attached to the casing 11. Resilient deformation of the partition plate rotation spring 27 causes a force attempting to rotate the partition plate 26 counterclockwise and to displace the partition plate 26 to the collection position (see FIG. 3A) to act. For ease of explanation, hereafter the partition plate rotation shaft 25 and the partition plate rotation spring 27 will be collectively referred to as a partition plate displacement section.

On the other hand, in the banknote processing device 1 (FIG. 2), a partition plate drive section 29 is provided at a position adjacent to portion toward a right upper end of the rear face of the reject/collection box 8. The partition plate drive section 29 includes a specific solenoid, a displacement member for displacing in the front-rear direction, and a link mechanism etc. (none of which are illustrated in the drawings), with the displacement member being able to displace toward the front side or the rear side under control of the control unit 3. An engaging portion configured with a specific shape is also provided to a front end of the displacement member.

An engaged portion (as described later) configured with a specific shape is provided more downward at the vicinity of the rear end of the partition plate 26 of the reject/collection box 8 (see FIG. 3A and FIG. 3B). In the casing 11, a hole, indent, or the like (not illustrated in the drawings) is appropriately formed in the vicinity of the engaged portion for the displacement member and the like of the partition plate drive section 29 to be inserted through. The engaged portion of the partition plate 26 accordingly engages with the engaging portion of the partition plate drive section 29 (FIG. 2) when the reject/collection box 8 has been mounted to the banknote processing device casing 2, enabling interlocking to the displacement member of the partition plate drive section 29.

The banknote processing device 1 (FIG. 2) is configured such that, in a state in which reject/collection box 8 has been mounted, when the displacement member of the partition plate drive section 29 is displaced to the rear side, the engaged portion provided to the partition plate 26 of the reject/collection box 8 (FIG. 3A and FIG. 3B) is pulled rearward.

Thus in the reject/collection box 8, the partition plate 26 is accordingly rotated clockwise, and displaced to the reject position (FIG. 3B). The partition plate 26 is inclined in the reject position such that the front side thereof is lower than the rear side thereof.

The banknote processing device 1 (FIG. 2) is configured such that, in a state in which the reject/collection box 8 has been mounted, when the displacement member of the partition plate drive section 29 is displaced to the front side, the engaged portion provided to the partition plate 26 of the reject/collection box 8 (FIG. 3A and FIG. 3B) is pushed forward. Resilient force of the partition plate rotation spring 27 (FIG. 3A and FIG. 3B) also acts on the partition plate 26. In the reject/collection box 8, the partition plate 26 is accordingly rotated counterclockwise and displaced to the collection position (FIG. 3A). The partition plate 26 is inclined in this collection position such that the front side thereof is higher than the rear side thereof.

The reject/collection box 8 accordingly functions as a collection box that stores collection banknotes in the collection storage space 12A when the partition plate 26 has been positioned in the collection position (FIG. 3A). The reject/collection box 8 also functions as a reject box that stores reject banknotes in the reject storage space 12B when the partition plate 26 has been positioned in the reject position (FIG. 3B).

### 3. Configuration of Partition Plate and Function of Each Section

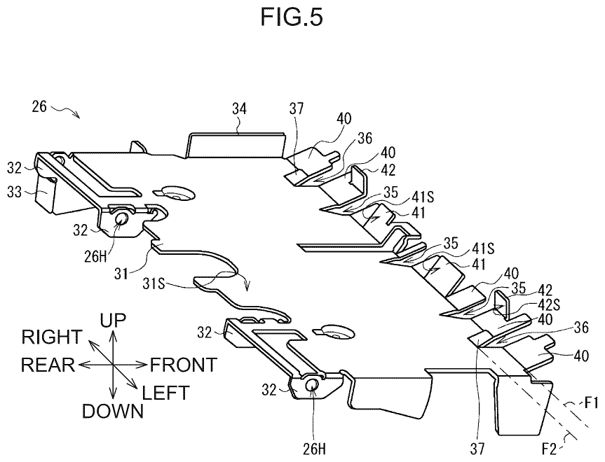

Detailed description next follows regarding a configuration of the partition plate 26. As illustrated in the perspective view of FIG. 5, the partition plate 26 is configured by, for example, cutting specific shapes out from a thin plate-shaped steel plate and also appropriately bending each portion, and has sufficient rigidity so as not to be easily distorted.

The partition plate 26 is configured centered on a partition plate member 31. The partition plate member31 is configured in a plate shape that is long in the left-right direction, short in the front-rear direction, and thin in the vertical direction. A partition plate placement face 31S that is the upper face of the partition plate member31, and the lower face thereof, are both formed with flat planar profiles. The partition plate member31 is formed with plural projections that point forward and upward from a main body front end line F1, which indicates the front end of the partition plate member31 (described in detail later). The partition plate 26 thereby deters a front end of a banknote that has been placed on the partition plate placement face 31S from jutting out further forward than the main body front end line F1.

A rotation support portion 32 is provided projecting out at each of four locations separated in the left-right direction in the vicinity of a rear end of the partition plate member31, by parts thereof being bent downward. A shaft hole 26H configured by a round hole piercing through in the left-right direction is provided in each of the rotation support portions 32 at respective positions such that all lie on the same axis. The partition plate rotation shaft 25 is inserted through these shaft holes 26H as described above (see FIG. 3A and FIG. 3B).

An engaged portion 33 is provided at the rear-lower side of a right end of the partition plate member31. The engaged portion 33 engages with the engaging portion (not illustrated in the drawings) provided to the displacement member of the partition plate drive section 29 (FIG. 2), as described above. A right restriction plate 34 is provided projecting upward at a front side of the right end of the partition plate member31. The right restriction plate 34 limits a displaceable range toward the right of banknotes (namely reject banknotes) placed on the partition plate placement face 31S.

As illustrated in FIG. 4, the front end side of the partition plate member31 includes cutout portions 35 and 36 formed cutting in toward the rear direction at respective locations corresponding to each of the flipper rollers 18 in relation to the left-right direction. At the front end side of the partition plate member 31, the cutout portions 35 are formed at three respective locations corresponding to the three flipper rollers 18 positioned at the center side in relation to the left-right direction. These cutout portions 35 reduce force acting on the partition plate 26 from the flippers 18B when the flipper rollers 18 are rotated.

At the front end side of the partition plate member 31, the cutout portions 36 are formed at two locations respectively corresponding to the two flipper rollers 18 positioned at the outside in relation to the left-right direction. These cutout portions 36, similarly to the cutout portions 35, reduce force acting on the partition plate 26 from the flippers 18B when the flipper rollers 18 are rotated. Rear ends of the cutout portions 36 reach to a cutout line rear end line F2 further to the rear side than the main body front end line F1, and end protection projections 37 are provided projecting out from these rear ends in a diagonally forward and upward direction. The end protection projections 37 perform the role of preventing end portions of banknotes (i.e., reject banknotes) that have been placed on the partition plate placement face 31S from catching on inside faces or the like of the cutout portions 36. In cases in which banknotes have been placed on the placement location 26U on the partition plate placement face 31S of the partition plate 26, the banknotes are assumed to be placed in a state riding up over the end protection projections 37.

Furthermore, at the front end side of the partition plate member 31, plural front end inclined portions 40 and two first restriction members 41 are provided projecting out upward and diagonally forward from the main body front end line F1. These two first restriction members 41 are, as illustrated in FIG. 4, respectively provided at locations corresponding to the upper rollers 16 and the lower rollers 17 in relation to the left-right direction. Each of the front end inclined portions 40 is respectively provided to a portion on the front end side of the partition plate member31 other than a location where the cutout portions 35 and 36 or the first restriction members 41 are provided. The front end inclined portions 40 have upper faces and lower faces that are both formed flat, and are inclined at a comparatively small angle with respect to the partition plate placement face 31S.

In the reject/collection box 8, in a state in which the partition plate 26 is positioned at the collection position (FIG. 3A), the banknotes discharged from the discharge section 13 ideally progress along the imaginary discharge line X13 corresponding to a design trajectory. However, in the actual reject/collection box 8, the banknotes discharged from the discharge section 13 sometimes progress so as to deviate from the imaginary discharge line X13 due to various reasons. In particular, there is a possibility of colliding with the front end of the partition plate 26 and causing a jam to occur in cases in which there is deviation thereof from the imaginary discharge line X13 to the upper side at a comparatively front side.

In such cases, avoiding collision of the banknote with the partition plate 26 by separating the partition plate 26 upward from the imaginary discharge line X13 might be considered. However, in the reject/collection box 8, disposing the partition plate 26 further upward in the casing 11 than the existing state is difficult due to various limitations, these being the vertical direction size of the casing 11, and the vertical direction position of the discharge section 13 while securing the vertical direction length of the collection storage space 12A.

Therefore, in the partition plate 26, banknotes discharged from the discharge section 13 are preemptively prevented from colliding with and catching on the front end of the partition plate 26 by providing the front end inclined portions 40 that are inclined upward and diagonally forward from the front end of the partition plate member31. In this case the partition plate 26 is able to guide such banknotes diagonally rearward and downward along the lower face of the front end inclined portions 40 and the partition plate member31.

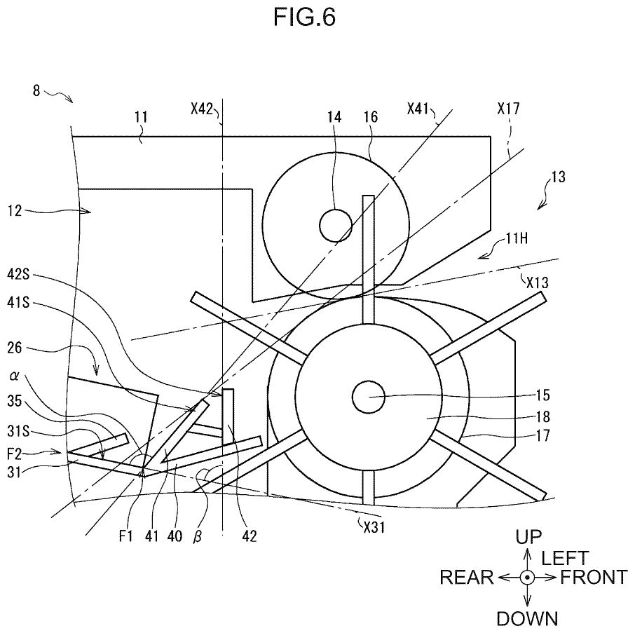

FIG. 6 depicts an enlargement of the vicinity of the front end of the partition plate 26 and a portion in in the vicinity of the discharge section 13 of FIG. 3A and FIG. 3B. In FIG. 6, the imaginary discharge line X13 that is a common tangent to the upper rollers 16 and the lower rollers 17 of the discharge section 13 corresponds to an ideal trajectory that banknotes discharged from the discharge section 13 should progress along, as described above with reference to FIG. 3A. An imaginary straight line X31 indicated in FIG. 6 corresponds to an imaginary plane from hypothetically extending the partition plate placement face 31S of the partition plate member31. This imaginary straight line X31 is inclined downward on progression forward.

The first restriction members 41 include first restriction surfaces 41S that are rear upper surfaces, namely surfaces for abutting the banknotes placed on the partition plate placement face 31S, with the first restriction surfaces 41S formed with a flat planar profile. The first restriction members 41 are inclined at a greater angle than the front end inclined portions 40 with respect to the imaginary plane (namely, imaginary straight line X31) that is the hypothetical extension of the partition plate placement face 31S of the partition plate member 31, as illustrated in FIG. 5 and FIG. 6. However, an angle α (see FIG. 6) formed between the first restriction surfaces 41S of the first restriction members 41, and the partition plate placement face 31S, is an obtuse angle greater than 90°.

Furthermore, on the plural front end inclined portions 40, second restriction members 42 are respectively provided at two locations disposed between a cutout portion 35 and a cutout portion 36 on the left or right, respectively, namely at locations lying at the outside in the left-right direction with respect to the two first restriction member 41 locations, so as to project upward. The second restriction members 42 include second restriction surfaces 42S that are surfaces on the rear side thereof facing substantially directly rearward when the partition plate 26 is in the reject position (FIG. 3B and FIG. 6). This means that in FIG. 6, an imaginary straight line X42 corresponding to an imaginary plane that is a hypothetical extension of the second restriction surfaces 42S is a straight line substantially along the vertical direction. Accompanying this, an angle formed between the second restriction members 42 and the partition plate placement face 31S, namely an angle β (FIG. 6) formed between the imaginary straight line X42 and the imaginary straight line X31, is an acute angle smaller than 90°.

Moreover, lower ends of the second restriction members 42 are positioned further diagonally forward and upward than the main body front end line F1 of the front end inclined portions 40. In other words, the lower ends of the second restriction members 42 are positioned at locations slightly away from and at the upper side of the imaginary straight line X31. Furthermore, end portions on the upper side of the second restriction members 42 (namely, the stacking direction side) are positioned at the lower side than a first upper end tangent X17 (FIG. 6). This first upper end tangent X17 is a tangent that contacts the outer peripheral face of the lower rollers 17, and is an imaginary straight line passing through upper end portions of the first restriction members 41.

Thus at front end portions of the partition plate 26, in addition to the first restriction members 41 provided on the main body front end line F1 that is the front end of the partition plate member31, the second restriction members 42 are also provided on the front end inclined portions 40 further toward the front side than the first restriction members, namely the side in the vicinity of the discharge section 13.

### 4. Effects

For the configuration described above, in the reject/collection box 8 of the banknote processing device 1 according to the present exemplary embodiment, when banknotes are conveyed in by the conveyance section 5, these banknote are discharged into the storage space 12 by the discharge section 13. In this case, in the reject/collection box 8, collection banknotes are stored in the collection storage space 12A if the partition plate 26 is positioned at the collection position (FIG. 3A), and reject banknotes are stored in the reject storage space 12B if the partition plate 26 is positioned at the reject position (FIG. 3B).

In particular, in the reject/collection box 8, the banknotes discharged from the discharge section 13 are placed on the placement location 26U on the partition plate placement face 31S when the partition plate 26 is at the reject position (FIG. 3B and FIG. 6), and a forward movement range of the banknotes is restricted by the first restriction members 41.

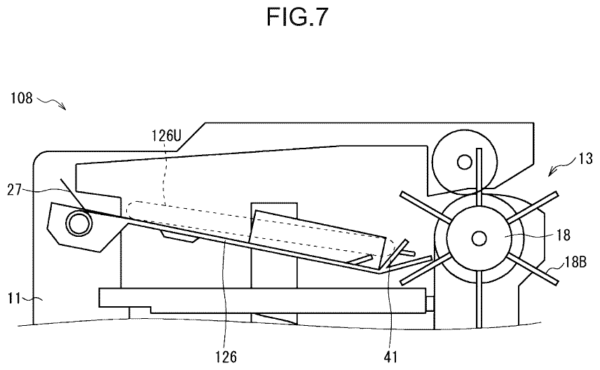

Consider here a hypothetical reject/collection box 108 such as illustrated in FIG. 7, corresponding to FIG. 3B, as a subject of comparison to the reject/collection box 8. The reject/collection box 108 is provided with a partition plate 126 instead of the partition plate 26. The partition plate 126 is configured by omitting the second restriction members 42 from the partition plate 26 of the present exemplary embodiment.

In the hypothetical reject/collection box 108, when a banknote placed on a placement location 126U rides up on the first restriction members 41 due to some reason or other, the banknote is pulled forward by flippers 18B of flipper rollers 18, and a front end thereof is displaced as far as a position abutting an inside face of the casing 11. When this occurs, a portion in the front end vicinity of the banknote abuts a vicinity of a base portion of the flippers 18B of the flipper rollers 18. In such cases, in the reject/collection box 108, when an attempt is made to rotate the partition plate 126 from the reject position to the collection position (FIG. 3A), there is a possibility that force acting on the banknote due to friction etc. against the flippers 18B becomes larger than force acting from the partition plate drive section 29 and the partition plate rotation spring 27. Namely, there is a concern in the reject/collection box 108 that the partition plate 126 may not be able to be rotated to the collection position due to the banknote that has ridden up on the first restriction members 41.

In contrast thereto, in the reject/collection box 8 of the present exemplary embodiment (FIG. 3A to FIG. 6), the second restriction members 42 are provided on the partition plate 26 at the front side of the first restriction members 41. Therefore, in the reject/collection box 8, even if a banknote placed on the placement location 26U has ridden up on the first restriction members 41 due to some reasons, the front end of the banknote can be confined to a position abutting the second restriction members 42, namely, at a position slightly to the rear and away from the inside face of the casing 11. At this point a portion in the vicinity at the front end of the banknote is slightly separated from the vicinity of base portions of the flippers 18B of the flipper rollers 18.

In such cases, in the reject/collection box 8, when the partition plate 26 is to be rotated from the reject position to the collection position (FIG. 3A), force acting on the banknote from friction etc. against the flippers 18B is suppressed to smaller than force acting due to the partition plate drive section 29 and the partition plate rotation spring 27. Therefore, in the reject/collection box 8, even if there is a banknote that has ridden up on the first restriction members 41, the partition plate 26 can still be rotated to the collection position by resilient force etc. acting from the partition plate rotation spring 27.

Moreover, the partition plate 26 is configured such that the second restriction members 42 are provided not to the partition plate member31 itself, but on the front end inclined portions 40 that have been provided projecting out at the front end of the partition plate member31 (FIG. 4 to FIG. 6). In other words, the second restriction members 42 are provided at the upper side of the partition plate 26, even without providing additional other portions further to the lower side and front side than the front end inclined portions 40, which is already provided. Therefore, in the reject/collection box 8, in a state in which the partition plate 26 is positioned at the collection position (FIG. 3A), even suppose a banknote discharged from the discharge section 13 had deviated to the upper side of the imaginary discharge line X13, then the banknote can be guided diagonally rearward and downward by lower faces of the front end inclined portions 40 and the partition plate member31. Namely, although the second restriction members 42 have been additionally provided in the reject/collection box 8, banknotes can be prevented from colliding with and catching on the front end of the partition plate 26 and causing a jam, similarly to hitherto.

Moreover, in the partition plate 26, the angle α (FIG. 6), which is formed between the partition plate placement face 31S and the first restriction surfaces 41S of the first restriction members 41, is an obtuse angle greater than 90°. For this angle a, although an acute angle less than 90°would be ideal for the purpose of restricting banknotes placed on the placement location 26U in the reject position (FIG. 3B and FIG. 6), an obtuse angle is employed therefor as a result of also considering an advantageous effect of avoiding of banknotes discharged from the discharge section 13 from catching when in the collection position (FIG. 3A).

However, the second restriction members 42 are provided projecting out at the upper side of the front end inclined portions 40 as described above, and so there is no need to consider catching of banknotes in a situation in which the partition plate 26 is positioned at the collection position (FIG. 3A). Therefore, for the second restriction members 42, an acute angle can be adopted for the angle β (FIG. 6) formed between the second restriction surfaces 42S and the partition plate placement face 31S.

Thus in cases in which a banknote that has ridden up on the first restriction members 41 has abutted the second restriction surfaces 42S with the partition plate 26 in the reject position (FIG. 3B and FIG. 6), a front end portion of the banknote can be guided in a downward direction along the second restriction surfaces 42S. This thereby means that, in the partition plate 26, a possibility that such a banknote rides over the second restriction members 42, namely a possibility that a sufficiently large force acts between the flippers 18B of the flipper rollers 18 and the banknote such that the partition plate 26 is no longer able to rotate to the collection position (FIG. 3A), can suppressed to an extremely low possibility.

Furthermore, in the partition plate 26, the upper end of the second restriction members 42 is configured so as to be positioned further to the lower side than the first upper end tangent X17 (FIG. 6). In the partition plate 26, the position of the upper end of the first restriction members 41 is determined such that a possibility of a banknote catching on the upper end of the first restriction members 41 is sufficiently low even if a banknote discharged from the discharge section 13 has progressed by deviating below the imaginary discharge line X13. Namely, in the reject/collection box 8, the possibility that a banknote discharged from the discharge section 13 progresses further to the lower side than the first upper end tangent X17 is extremely low. Considering this point, in the reject/collection box 8, the possibility that banknotes discharged from the discharge section 13 catch on the second restriction members 42 can be suppressed to extremely low by the upper ends of the second restriction members 42 too also being positioned at the lower side of the first upper end tangent X17.

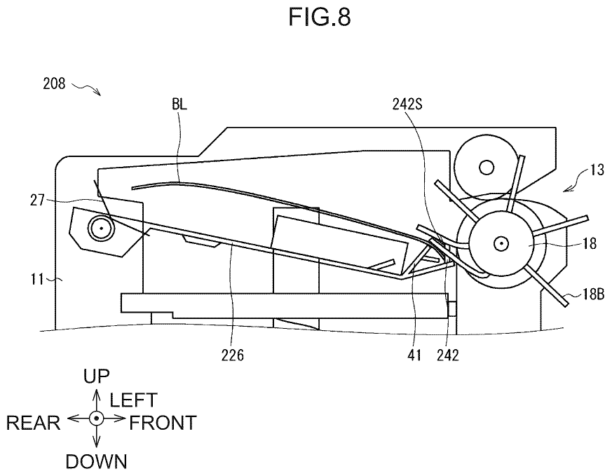

In the reject/collection box 8, there would be a concern regarding not being able to appropriately restrict forward displacement of the banknote in cases in which the position of the second restriction members 42 on the partition plate 26 is unsuitable in relation to the front-rear direction. For example, a hypothetical reject/collection box 208 illustrated in FIG. 8, corresponding to FIG. 3B, has a partition plate 226 provided instead of the partition plate 26. Instead of the second restriction members 42, second restriction members 242 are provided to this partition plate 226 at positions further toward the front side, namely at positions nearer to the discharge section 13, than the second restriction members 42.

In the reject/collection box 208, in cases in which a front end portion of a banknote BL placed on the partition plate 226 has ridden up on the first restriction members 41, the banknote is immobilized at a position abutted against second restriction surfaces 242S that are surfaces on the rear side of the second restriction members 242. However, in the reject/collection box 208, a leading end portion of the banknote BL reaches a position sufficiently near to a base portion of the flippers 18B of the flipper rollers 18.

Therefore, in the reject/collection box 208, similarly to in cases in which the hypothetical reject/collection box 108 described above (FIG. 7), there is a possibility that a force acting on the banknote BL from friction etc. against the flippers 18B is larger than a force acting due to the partition plate drive section 29 and the partition plate rotation spring 27. Namely, in the reject/collection box 208, there is a concern that the partition plate 226 might no longer be rotatable to the collection position due to the banknote BL that has ridden up on the first restriction members 41.

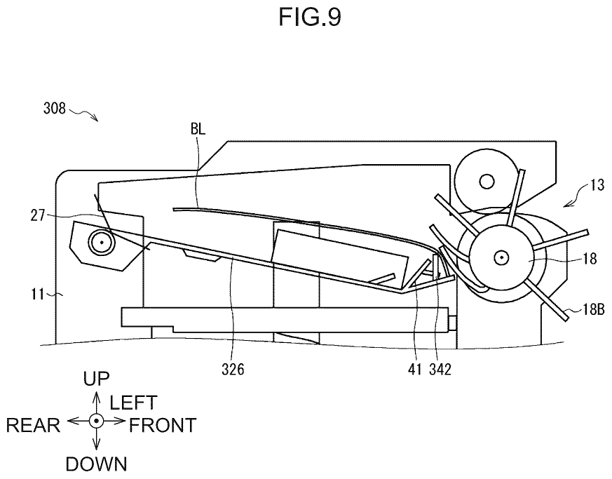

Moreover, for example, in a hypothetical reject/collection box 308 illustrated in FIG. 9, corresponding to FIG. 3B, a partition plate 326 is provided instead of the partition plate 26. In the partition plate 326, instead of the second restriction members 42, second restriction members 342 are provided at positions further to the rear side, namely at positions nearer to the first restriction members 41, than the second restriction members 42.

In the reject/collection box 308, in cases in which a front end portion of a banknote BL placed on the partition plate 326 has ridden up on the first restriction members 41, there is a high possibility that the banknote BL easily also rides up over the second restriction members 342 that are in close proximity of the first restriction members 41. In such cases, in the reject/collection box 308, similarly to the reject/collection box 108 (FIG. 7), a leading end portion of the banknote BL reaches a position sufficiently close to a base portion of the flippers 18B of the flipper rollers 18.

This means that in the reject/collection box 308, as expected and similarly to cases of the reject/collection box 108 (FIG. 7), there is a possibility that the force acting on the banknote BL from friction etc. against the flippers 18B becomes larger than a force acting due to the partition plate drive section 29 and the partition plate rotation spring 27. Namely, there is a concern in the reject/collection box 308 that the partition plate 326 might no longer be able to be rotated to the collection position due to the banknote BL that has successively ridden up over the first restriction members 41 and second restriction members 342.

Considering this point, in the reject/collection box 8, a position of the second restriction members 42 on the partition plate 26 is appropriately set in relation to the front-rear direction. Therefore, in the reject/collection box 8, even suppose a banknote placed on the placement location 26U has ridden up on the first restriction members 41, the banknote abuts the second restriction surfaces 42S of the second restriction members 42 and can be confined to a position sufficiently away from the base portions of the flippers 18B of the flipper rollers 18. Thus in the reject/collection box 8, the partition plate 26 can be smoothly rotated and displaced between the reject position (FIG. 3B) and the collection position (FIG. 3A).

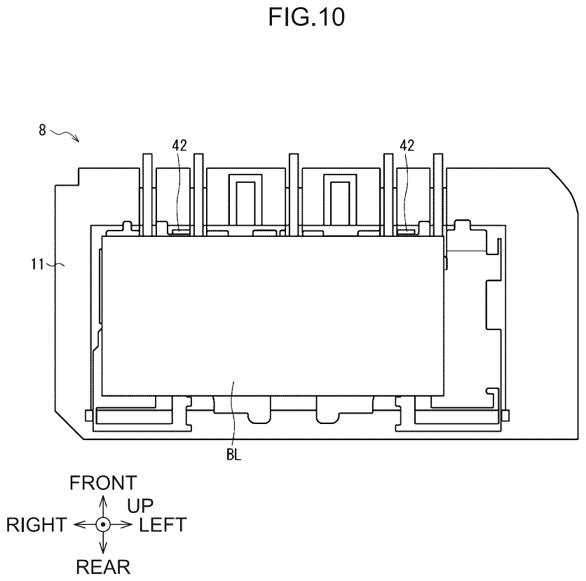

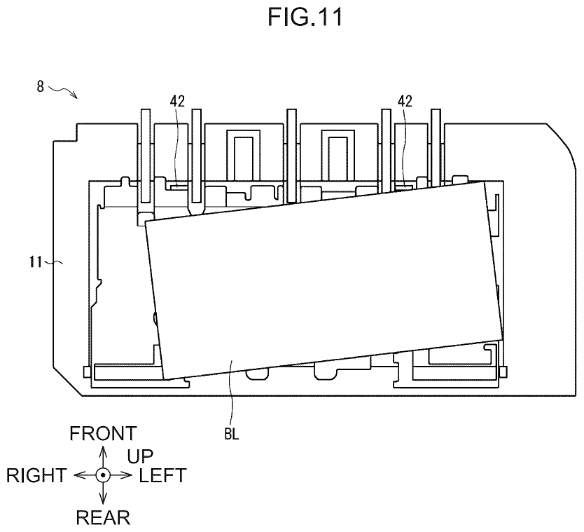

In the reject/collection box 8, ideally banknotes BL have paper faces substantially parallel to the partition plate placement face 31S on the partition plate 26, with the long sides thereof oriented along the left-right direction and the short sides thereof oriented along the front-rear direction (hereafter referred to as an ideal orientation), as illustrated in FIG. 10, corresponding to FIG. 4. However, in the reject/collection box 8, in reality there are cases in which the banknotes BL placed on the partition plate 26 are rotated on the partition plate placement face 31S, namely cases in which a so-called skew has occurred, as illustrated in FIG. 11.

In the reject/collection box 8, in cases in which a banknote placed on the partition plate placement face 31S reaches the flippers 18B of the flipper rollers 18 as described above, each portion of the front end of the banknote is pulled forward by the flippers 18B accompanying rotation of the flipper rollers 18. For the banknote in such cases, although a rotation angle from an ideal orientation (hereafter referred to as a skew angle) gradually approaches an orientation in which an edge at the front side thereof abuts the first restriction members 41 at two locations, or the second restriction members 42 at two locations, namely the ideal orientation (FIG. 10), the amount of rotation angle reduction is small. Therefore, in the reject/collection box 8, preferably a skew of the banknote BL does not occur, and even suppose one were to occur, preferably the skew angle is as small as possible.

In the reject/collection box 8, a rearward movement range of the banknote BL is restricted by the inside face at the rear side of the casing 11, and together with this a forward movement range thereof is restricted by the first restriction members 41 at two locations or by the second restriction members 42 at two locations. Therefore, in the reject/collection box 8, in cases in which a banknote BL has ridden up on the first restriction members 41, the skew angle is at a maximum in a state in which the left or right vertex at the rear side thereof has abutted the inside face at the rear side of the casing 11, and also an edge at a front side thereof has abutted one or other out of the second restriction members 42.

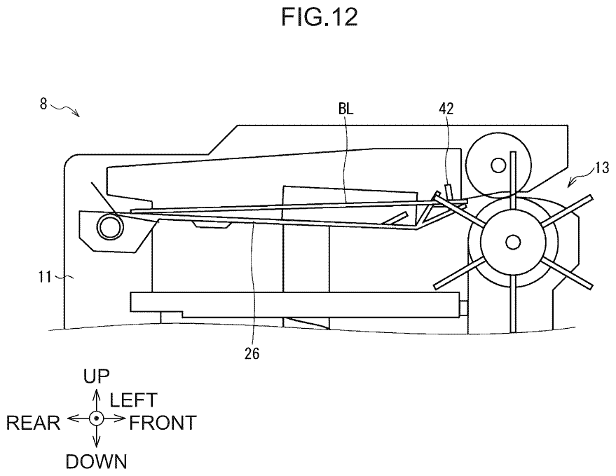

Namely, in the reject/collection box 8, the maximum skew angle that may be exhibited by the banknote BL becomes larger as the positions of the second restriction members 42 approach the left-right direction inside. In the reject/collection box 8, when the skew angle of the banknote BL becomes too large there is a possibility that, as illustrated in FIG. 11, a vertex vicinity of the banknote sticking out to the front side is in extremely close proximity to, or abuts, the inside face at the front side of the inside of the storage space 12. In such cases, in the reject/collection box 8 there is a concern that, when rotating the partition plate 26 from the reject position (FIG. 3B) to the collection position (FIG. 3A), as illustrated in FIG. 12, the banknote BL might catch on other components or the like formed inside the casing 11, and displaced to the collection position might no longer be possible. Due to this reason, in the partition plate 26, preferably the second restriction members 42 are arranged as far as possible toward the left-right direction outside.

On the other hand, in the reject/collection box 8, suppose that the second restriction members 42 are arranged comparatively far to the outside in the left-right direction, there is a concern that the short edge of the banknote BL placed on the partition plate 26 might catch on the second restriction members 42, and that the skew angle can no longer be reduced even when each portion is pulled forward by the flipper rollers 18. Due to this reason, in the partition plate 26, the second restriction members 42 are preferably arranged as far as possible toward the inside in the left-right direction.

Thus in the reject/collection box 8, after general research, the positions of the second restriction members 42 in relation to the left-right direction are set as locations that are further outside than the first restriction members 41, and are slightly to the inside than the outermost portions. Therefore, in the reject/collection box 8, the possibility that a skew occurs in the banknote BL placed on the partition plate 26 can be reduced, or the skew angle can be suppressed to a comparatively small angle if a skew has occurred. In the reject/collection box 8, the partition plate 26 can be thereby smoothly rotated from the reject position (FIG. 3B) to the collection position (FIG. 3A).

By adopting the configuration described above, in the reject/collection box 8 of the banknote processing device 1, the first restriction members 41 are provided at the front end of the partition plate member31 of the partition plate 26, and also the second restriction members 42 are provided thereto with the front end inclined portions 40 interposed therebetween at the front side of the first restriction members 41. In the reject/collection box 8, even though a banknote placed on the placement location 26U has ridden up on the first restriction members 41, the front end of the banknote abuts the second restriction members 42, and is sufficiently separated from the vicinity of base portions of the flippers 18B of the flipper rollers 18. Therefore, in the reject/collection box 8, when rotating the partition plate 26 from the reject position to the collection position, a force acting on the banknote from friction and the like against the flippers 18B can be suppressed to small, enabling smooth rotation to the collection position.

### 5. Other Exemplary Embodiments

Note that in the exemplary embodiments described above, an embodiment has been described in which the angle β (FIG. 6) formed between the second restriction surfaces 42S of the second restriction members 42 and the partition plate placement face 31S is an acute angle smaller than 90°. However, the present disclosure is not limited thereto and, for example, the angle β may be an angle of 90° or greater.

Moreover, in the exemplary embodiments described above an embodiment has been described in which the angle α (FIG. 6) formed between the first restriction surfaces 41S of the first restriction members 41 and the partition plate placement face 31S is an obtuse angle greater than 90°. However, the present disclosure is not limited thereto and, for example, the angle α may be an angle of 90° or smaller.

Furthermore, in the exemplary embodiments described above an embodiment has been described in which the second restriction members 42 are provided so as to project out on the front end inclined portions 40 that have been provided pointing in a direction diagonally forward and upward with respect to the partition plate member31 of the partition plate 26 (FIG. 5, FIG. 6, etc.). However, the present disclosure is not limited thereto and, for example, the second restriction members 42 may be provided so as to project out on the partition plate member31.

Furthermore, in the exemplary embodiments described above an embodiment has been described in which the upper ends of the second restriction members 42 are positioned further to the lower side than the first upper end tangent X17 (FIG. 6) in a state in which the partition plate 26 is positioned in the reject position (FIG. 3B). However, the present disclosure is not limited thereto and the upper ends of the second restriction members 42 may be positioned further to the upper side than the first upper end tangent X17. In such cases a banknote discharged from the discharge section 13 should be configured not to catch on the second restriction members 42 when deviated downward from the imaginary discharge line X13.

Furthermore, in the exemplary embodiments described above an embodiment has been described in which the second restriction members 42 are provided to two locations at the outside with respect to the respective two locations of the first restriction members 41 in relation to the left-right direction (see FIG. 4, FIG. 5, etc.). However, the present disclosure is not limited thereto and, for example, the second restriction members 42 may be provided at two locations at the inside of the two locations of the first restriction members 41 in relation to the left-right direction.

Furthermore, in the exemplary embodiments described above an embodiment has been described in which there are two of the first restriction members 41 provided to the partition plate 26 and there are also two of the second restriction members 42 provided thereto (FIG. 4, FIG. 5, etc.). However, the present disclosure is not limited thereto, and there may be one or three or more of the first restriction members 41 provided to the partition plate 26, and/or there may be one or three or more of the second restriction members 42 provided thereto.

Furthermore, in the exemplary embodiments described above an embodiment has been described in which two upper rollers 16, two lower rollers 17, and five flipper rollers 18 are provided to the discharge section 13. However, the present disclosure is not limited thereto and, for example, one or three or more of the upper rollers 16, one or three or more of lower rollers 17, and/or four or six or more of the flipper rollers 18 may be provided. In such cases, preferably the same number is provided of the upper rollers 16 and the lower rollers 17, and preferably they are provided at positions corresponding to each other in relation to the left-right direction. The flipper rollers 18 can be arranged at various positions not interfering with the lower rollers 17 in relation to the left-right direction. Moreover, in such cases, the number and positions of the front end inclined portions 40, the first restriction members 41, and the second restriction members on the partition plate 26 are preferably set in accordance with the positions in relation to the left-right direction of the upper rollers 16 and the lower rollers 17, and also the flipper rollers 18, and also the respective shapes etc. thereof are preferably appropriately corresponded thereto.

Furthermore, in the exemplary embodiments described above an embodiment has been described in which the partition plate 26 is configured from a steel plate, namely a metal material. However, the present disclosure is not limited thereto and, for example, the partition plate 26 may be configured from various materials, such as a resin material or the like.

Furthermore, in the exemplary embodiments described above an embodiment has been described in which the partition plate 26 is displaced to the collection position (FIG. 3A) or the reject position (FIG. 3B) by rotating about the partition plate rotation shaft 25. However, the present disclosure is not limited thereto and, for example, the partition plate 26 may be displaced to the collection position or the reject position by a translation movement (sliding) in the vertical direction using a specific slide mechanism or the like.

Furthermore, in the exemplary embodiments described above an embodiment has been described in which the partition plate drive section 29 is provided at the banknote processing device casing 2 side. However, the present disclosure is not limited thereto and the partition plate drive section 29 may be provided at the casing 11 side of the reject/collection box 8. In such cases, the partition plate 26 can be displaced by supplying a control signal from the banknote processing device casing 2 side to a solenoid provided to the partition plate drive section 29 through a specific connection terminal or the like (not illustrated in the drawings).

Furthermore, in the exemplary embodiments described above an embodiment has been described in which there is one reject/collection box 8 provided to the banknote processing device 1. However, the present disclosure is not limited thereto and two or more reject/collection boxes 8 may be provided to the banknote processing device 1.

Furthermore, in the exemplary embodiments described above an embodiment has been described in which the present disclosure is applied to the banknote processing device 1 incorporated in a change machine that is a checkout machine operated by a cashier. However, there is no limitation thereto and, for example, the present disclosure may be applied to a banknote processing device incorporated in a self-checkout machine operated by customers themselves, or a semi-self checkout machine.

Furthermore, in the exemplary embodiments described above an embodiment has been described in which the present disclosure is applied to the banknote processing device 1 of a change machine that performs banknote pay-in/pay-out processing and is connected to a POS register used at the checkout register location of a supermarket, convenience store, or the like. However, there is no limitation thereto and, for example, the present disclosure may be applied to various devices that handle banknotes, such as terminals used by bank staff, for example automated teller machines (window terminals) used inside a bank.

Furthermore, the present disclosure is not limited to the above exemplary embodiments and other exemplary embodiments. Namely in the present disclosure, the applicable range of the present disclosure encompasses exemplary embodiments resulting from feely selecting a combination of part or all of the above exemplary embodiments and above other exemplary embodiments. Moreover in the present disclosure, the applicable range of the present disclosure encompasses cases in which part of the configuration of a freely selected exemplary embodiment from out of the exemplary embodiments described above and the other exemplary embodiments described above has been extracted, and replaces/is used as part of the configuration for a freely selected exemplary embodiment from out of the above exemplary embodiments and other exemplary embodiments, and cases in which the extracted part of the configuration is added to a freely selected exemplary embodiment.

Furthermore, in the exemplary embodiments described above an embodiment has been described in which the reject/collection box 8 is configured as a medium storage from the casing 11 serving as a casing, the discharge section 13 serving as a discharge section, the partition plate 26 serving as a partition plate, the partition plate rotation shaft 25 and the partition plate rotation spring 27 serving as a partition plate displacement section, the flipper rollers 18 each serving as a rotation member, the first restriction members 41 each serving as a first restriction member, and the second restriction members 42 each serving as second restriction member. However, the present disclosure is not limited thereto and a medium storage may be configured from a casing, a discharge section, a partition plate, a partition plate displacement section, a rotation member (or impeller), a first restriction member, and a second restriction member having various other configurations.

### INDUSTRIAL APPLICABILITY

The present disclosure may, for example, be utilized for a banknote processing device incorporated in a checkout machine installed at a checkout location of a retailer.

1. A medium storage comprising:
a casing including an internal storage space for storing a paper leaf-shaped medium in a state stacked along a stacking direction;
a discharge section for discharging the medium into the storage space;
a partition plate that partitions an interior of the storage space into a first storage space at a first side thereof, the first side being a side opposite to the stacking direction, and a second storage space at a second side, which is a side of the stacking direction, the partition plate being provided with a placement location for placing the medium on a placement face that is a surface on the second side thereof;
a partition plate displacement section that displaces the partition plate between a first position that causes the medium discharged from the discharge section to progress into the first storage space, and a second position that is positioned further toward the first side than the first position and that causes the medium discharged from the discharge section to progress into the second storage space;
a rotating member that includes one or more resiliently deformable resilient member extending in a direction away from a center axis disposed along a width direction orthogonal to the stacking direction, and that rotates about the center axis so as to assist stacking of the medium discharged into the storage space;
a first restriction member that is provided at the first side of the partition plate on the discharge section side of the placement location, and that restricts a movement range toward the discharge section side of the medium placed on the placement location; and
a second restriction member that is provided at the first side of the partition plate further toward the discharge section side than the first restriction member, and that restricts a movement range toward the discharge section side of the medium placed on the placement location.

2. The medium storage of claim 1, wherein:
the second restriction member is provided at a position separated in the stacking direction from the placement face, or from a plane that is a hypothetical extension of the placement face.

3. The medium storage of claim 1, wherein:
the discharge section includes a pair of rollers that are each rotatable and are arranged so as to be adjacent to each other substantially along the stacking direction, and discharges the medium from between the pair of rollers as they are rotated; and
the second restriction member is positioned such that, in a state in which the partition plate has been displaced to the second position, an end portion on the second side of the second restriction member is positioned further toward the first side than a hypothetical plane tangential to the roller positioned at the first side and passing through an end portion on the second side of the first restriction member.

4. The medium storage of claim 1, wherein:
an angle formed between a first restriction surface that is the surface on the placement location side of the first restriction member and the placement face is greater than 90°.

5. The medium storage of claim 1, wherein:
an angle formed between a plane of a hypothetical extension of a second restriction surface that is a surface on the placement location side of the second restriction member and a plane of a hypothetical extension of the placement face is less than 90°.

6. The medium storage of claim 1, wherein:
a second restriction surface that is a surface on the placement location side of the second restriction member is formed along the stacking direction in a state in which the partition plate has been displaced to the second position.

7. The medium storage of claim 1, wherein:
a position of the second restriction member in relation to the width direction is determined so as to limit a range of movement of the medium placed on the placement face of the partition plate to a range in which the medium does not interfere with the casing during the partition plate being displaced from the second position to the first position.

8. The medium storage of claim 1, wherein:
the second restriction member is disposed in relation to the width direction at a position on the partition plate further away from a center in the width direction than the first restriction member.

9. The medium storage of claim 1, wherein:
in cases in which the partition plate is displaced to the first position, the partition plate displacement section positions the partition plate further to the second side than an imaginary line that the medium discharged from the discharge section to be progress along.

10. The medium storage of claim 1, wherein:
the partition plate displacement section displaces the partition plate to the first position or the second position by rotating the partition plate about a partition plate rotation shaft disposed along the width direction and provided on an opposite side of the storage space to the displacement section.

11. The medium storage of claim 1, wherein:
the discharge section includes:
a first roller that rotates about the center axis; and
a second roller that is disposed so as to be adjacent to the first roller at substantially the second side thereof and that rotates about a second center axis;
the discharge section discharges the medium from between an outer peripheral face of the first roller and an outer peripheral face of the second roller;
the resilient member is a flipper extended further out than the outer peripheral face of the first roller with respect to the center axis; and
the rotation member is a flipper roller that rotates about the center axis so as to pull the medium placed on the placement face of the partition plate toward the discharge section side.

12. A medium processing device comprising:
a conveyance section that conveys a medium having a sheet-like shape; and
the medium storage of claim 1 for storing the medium.
